(19) United States
(12) Patent Application Publication
(10) Pub. No.: US 2002/0145297 A1
(43) Pub. Date: Oct. 10, 2002

(54) Slipsheet drawbar device and method therefore

(76) Inventor: Jeffrey D. Nickel, Fallston, MD (US)

Correspondence Address: U.S. ARMY Research Laboratory, Attn: AMSRL-CS-CC-IP, 2800 Powder Mill Rd., Adelphi, MD, 20783-1197, US

(21) Appl. No.: 09/828,442

(22) Filed: Apr. 9, 2001

(51) Int. Cl. B65G 7/00

(52) U.S. Cl. 294/104

(57) ABSTRACT

A slipsheet and a drawbar device to allow for repositioning of a load on the slipsheet that has a rigid base plate, one or more second plates attached to the rigid base plate. The second plate(s) act as a surface to apply pressure to the slipsheet. A mechanical attachment device is located between the plates allowing enough clearance such that the slipsheet can be slid between the plates. A means of releasing pressure on the mechanical attachment device from a locked position and a ring device mounted on the base plate near the rear as a means of applying a pulling force to the combination slipsheet and drawbar device.

### RIGHTS OF THE GOVERNMENT

The invention described herein may be manufactured, used, and licensed by or for the United States Government for governmental purposes without the payment to us of any royalty thereon.

### BACKGROUND OF THE INVENTION

1. Field of the Invention

This invention relates generally to the maneuvering of a load by means of a slipsheet. The invention relates more specifically to a method of using a device that facilitates engagement to, maneuvering of, and disengagement from, a loaded slipsheet with a positive locking device for safety and performance enhancement.

2. Discussion of Related Art

A slipsheet is a thin, flexible plate that acts both as a support for a load, and a means for grasping the load to maneuver it as a unit. A slipsheet constructed of a material such as high density polyethylene or of fiber reinforced paper can be very durable, allowing for multiple reuse or extended dragging even over harsh surfaces such as gravel or textured concrete.

Prior art includes a basic drawbar concept by this inventor as described in U.S. Pat. No. 6,120,238. That device proved difficult for the typically over-strained human in a quick response situation to use in muddy, wet, snowy, sandy and other conditions. Therefore, as described below, I have devised a major improvement design for the drawbar device.

### SUMMARY OF THE INVENTION

Accordingly, it is an object of the present invention to provide a device that advantageously facilitates the movement of a heavily loaded slipsheet in a way that shows a great improvement in time efficiency, safety for the operator, and reduced maintenance to the devices in prior art. Accordingly, the invention relates to an improved drawbar device and the new method of using the device that accomplishes all the goals of load manipulation in a more efficient manner. All advantages of the prior art have been transferred to this invention.

### BRIEF DESCRIPTION OF THE DRAWINGS

The invention will be better understood, and further objects, features, and advantages thereof will become more apparent from the following description of the preferred embodiment, taken in conjunction with the accompanying drawings in which:

FIG. 1 illustrates the “Multi-Bar Link” version of the present invention.

FIG. 2 illustrates the “Cam-Lock” version of the present invention.

FIG. 3 illustrates the “Twist-Lock” version of the present invention.

### DETAILED DESCRIPTION OF THE PREFERRED EMBODIMENTS

Slipsheets are used in distribution where the loads have been moved using common forklifts. A system like this saves weight and cube. For most commercial uses, increased cube availability is desired. Using the devices and procedures described herein, the process of load manipulation can be augmented using human power, with a greater degree of safety.

In a quick response situation, such as an early entry military action, disaster relief, or other humanitarian efforts, a limited amount of material handling resources and the critical element of time, could substantially effect the outcome of the efforts. With the use of the present invention, an improved drawbar device, and some manual effort, relatively heavy loads can be downloaded from trucks or ISO containers, or repositioned as needed, more quickly, safely and efficiently than before, where no material handling equipment (MHE) is available. This would allow the delivery vehicle to be released in much less time, allowing it to be reused and quicken the overall effort.

Materials or supplies are loaded on slipsheets at the point of origin, be it a factory, assembly location or depot. The items are then either shipped to a consumer location or stored until needed. When needed they can be delivered and unloaded by conventional means or by attaching this drawbar device to the load, performing the movement and removing the drawbar device. By adding this capability, the possibilities of the receiving group have been advanced and will allow logistics and transportation resources to be available for other actions more quickly.

The people needing the materials or supplies would approach the container or truck with a drawbar and a tow strap. They would align the drawbar with the tab of the slipsheet, protruding from under the load. The slipsheet tab would be slid into the device (or the drawbar slid over the tab) and locked applying the positive locking mechanism. Next, they would pull the slipsheeted load from the delivery medium or to a desired new position. This repositioning may be accomplished by the force of one or more humans or by attaching the strap to a vehicle or even beasts of burden. Releasing the slipsheet from the drawbar device is now a simple as releasing the single or set of locks of one of the release mechanisms described.

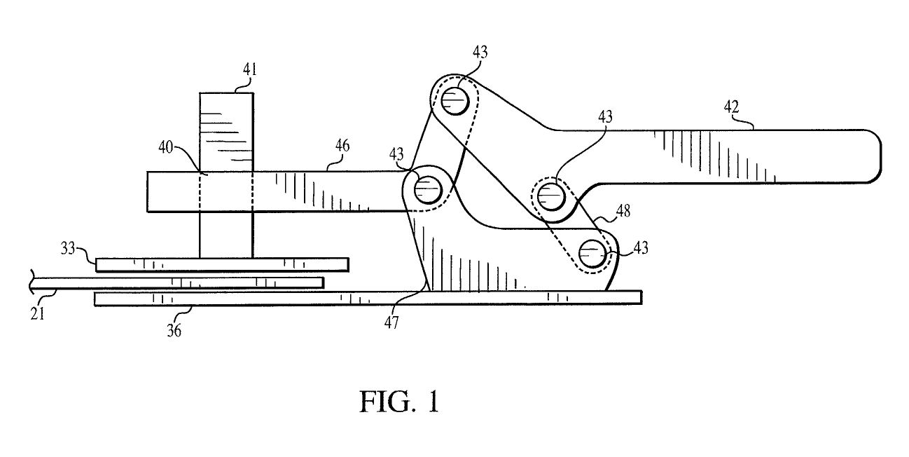

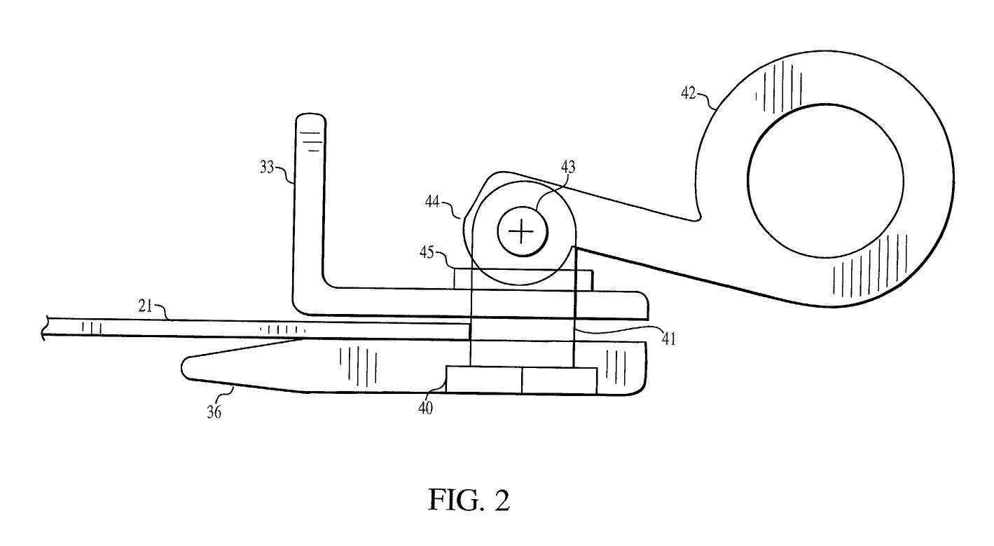

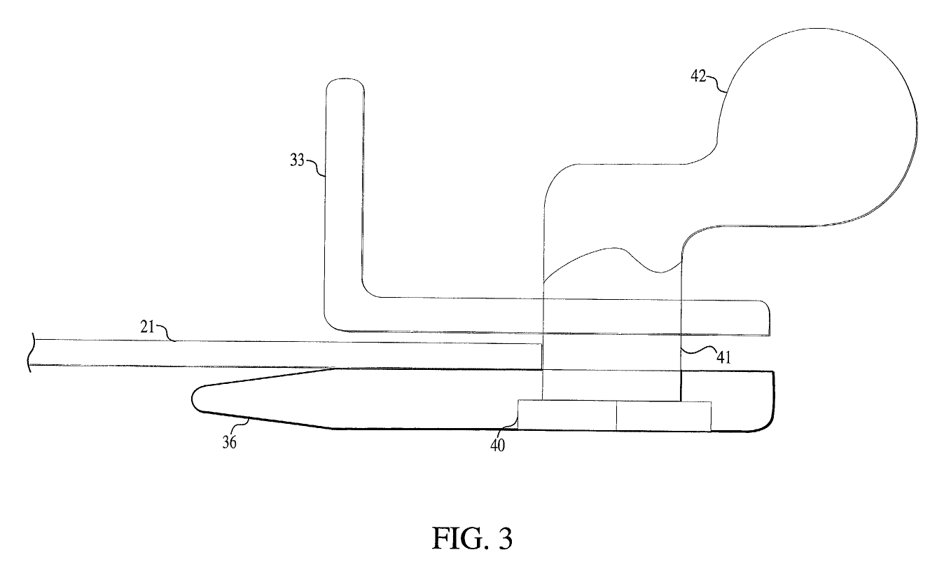

The included figures show views of various drawbar designs. All use the idea of the pressure on the slipsheet pushing against the device to hold it together. The ‘twist-lock’ (FIG. 3) and ‘cam-lock’ (FIG. 2) are very similar to each other but could constitute separate mechanisms. A ‘multi-bar link’ (FIG. 1) or a spring loaded lock is another possibility.

As shown in the figures, a slipsheet 21 and a drawbar device 30 associated therewith to allow for repositioning of a load on the slipsheet 21 with or without the use of MHE. The drawbar device 30 consists of a rigid base plate 36, strong enough so as to not to buckle during intended use and to maintain its desired configuration throughout the process, a second plate 33, or plurality of plates, mechanically-attached to the first rigid base plate 36 to develop a surface to apply pressure to the slipsheet 21, mechanical attachment device(s) located between plates 36 and 33 allowing enough clearance when the pressure is released as to allow the slipsheet 21 to be slid between the two plates 36 and 33, a means of releasing the pressure 42 of the mechanical attachment device(s) from their locked position, and a ring or similar device(s) as discussed in prior art, securely mounted on base plate 36 near the rear as a means of applying the required pulling force to the system.

It will be readily seen by one of ordinary skill in the art that the present invention fulfills all of the objects set forth above. After reading the foregoing specification, one of ordinary skill will be able to effect various changes, substitutions of equivalents and various other aspects of the present invention as broadly disclosed herein. It is therefore intended that the protection granted hereon be limited only by the definition contained in the appended claims and equivalents thereof.

Having thus shown and described what is at present considered to be the preferred embodiment of the present invention, it should be noted that the same has been made by way of illustration and not limitation. Accordingly, all modifications, alterations and changes coming within the spirit and scope of the present invention are herein meant to be included.

I claim:

1. In combination a slipsheet and a drawbar device to allow for repositioning of a load on the slipsheet comprising:
a rigid base plate;
at least one second plate attached to said rigid base plate, said at least one second plate acting as a surface to apply pressure to said slipsheet;
a mechanical attachment device located between said plates allowing enough clearance such that said slipsheet can be slid between said plates;
a means of releasing pressure on said mechanical attachment device from a locked position; and
a ring device mounted on said base plate near the rear as a means of applying a pulling force to said combination slipsheet and drawbar device.

2. The device of claim 1 wherein said plates are textured to add a more positive grip.

3. A process to quickly, safely and efficiently unload or relocate items on a slipsheet from a container, truck or other area, without the use of Material Handling Equipment comprising the steps of:
aligning a drawbar device as defined in claim 1 with an end tab at the edge of said slipsheet protruding from under the items;
positioning a mechanical attachment device to separate said plates so as to avoid interference;
sliding said drawbar device towards said slipsheet so as to position said slipsheet between said base plate and said second plate;
activating said mechanical attachment device so as to apply a clamping force to said slipsheet to exert a force required to maneuver said drawbar device to a desired location; and
releasing said drawbar device from said slipsheet by releasing said mechanical attachment device to thereby separate said plates thus releasing a locking force which secures said slipsheet allowing said drawbar device to be slid away from said slipsheet.
